(19) United States
(12) Patent Application Publication
(10) Pub. No.: US 2022/0346450 A1
(43) Pub. Date: Nov. 3, 2022

(54) HEATING BODY AND ELECTRONIC VAPORIZATION DEVICE

(71) Applicant: SHENZHEN SMOORE TECHNOLOGY LIMITED, Shenzhen (CN)

(72) Inventors: Zhenlong JIANG, Shenzhen (CN); Pei LI, Shenzhen (CN)

(21) Appl. No.: 17/730,689

(22) Filed: Apr. 27, 2022

(30) Foreign Application Priority Data
Apr. 28, 2021 (CN) 202110468493.1

(51) Int. Cl. A24F 40/46

(52) U.S. Cl. CPC A24F 40/46

(57) ABSTRACT

A heating body includes: a first heat conduction substrate; a second heat conduction substrate; and a heating element. The first heat conduction substrate, the heating element, and the second heat conduction substrate are sequentially stacked and fixedly connected. In an embodiment, surfaces of the first heat conduction substrate and surfaces of the second heat conduction substrate that are arranged close to each other both comprise planes; the heating element includes a first connection portion, a main heating portion, and a second connection portion that are sequentially connected; and the first connection portion and the second connection portion are electrically connectable to an external power supply such that the main heating portion is electrically connectable to the external power supply to implement heating.

### CROSS-REFERENCE TO PRIOR APPLICATION

Priority is claimed to Chinese Patent Application No. CN 202110468493.1, filed on Apr. 28, 2021, the entire disclosure of which is hereby incorporated by reference herein.

### FIELD

This application belongs to relates to the technical field of electronic vaporization devices, and in particular, to a heating body and an electronic vaporization device.

### BACKGROUND

Electronic vaporization devices such as electronic cigarettes can generally use a plug-in heating body, and the plug-in heating body is at least partially inserted into tobacco, to heat and vaporize the tobacco.

In an existing heating body, a circuit is formed by directly silk-screening a resistance paste on a ceramic substrate or a metal sheet with an insulating surface, resulting in insufficient strength of a final formed heating body. Therefore, when the substrate is deformed, the circuit is easily damaged, broken, and peeled off, and the heating body generates heat on a single surface, resulting in uniform heating temperatures on two opposite sides of the heating body.

### SUMMARY

In an embodiment, the present invention provides a heating body, comprising: a first heat conduction substrate; a second heat conduction substrate; and a heating element, wherein the first heat conduction substrate, the heating element, and the second heat conduction substrate are sequentially stacked and fixedly connected.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of an embodiment of a heating body according to this application;

FIG. 2 is an exploded view of an embodiment of the heating body shown in FIG. 1;

FIG. 3 is a cross-sectional view of an implementation of the heating body shown in FIG. 1 at an A-A′ section;

FIG. 4 is a cross-sectional view of another implementation of the heating body shown in FIG. 1 at an A-A′ section;

FIG. 5 is a cross-sectional view of another implementation of the heating body shown in FIG. 1 at an A-A′ section;

FIG. 6 is a cross-sectional view of another implementation of the heating body shown in FIG. 1 at an A-A′ section;

FIG. 7 is an exploded view of another implementation of the heating body shown in FIG. 1;

FIG. 8 is a cross-sectional view of another implementation of the heating body shown in FIG. 1 at an A-A′ section;

FIG. 9 is an exploded view of another implementation of the heating body shown in FIG. 1;

FIG. 10 is a cross-sectional view of another implementation of the heating body shown in FIG. 1 at an A-A′ section;

FIG. 11 is a schematic structural diagram of an embodiment of a heating element in a heating body according to this application;

FIG. 12 is a schematic structural diagram of another embodiment of a heating element in a heating body according to this application;

FIG. 13 is a schematic structural diagram of another embodiment of the heating element shown in FIG. 12; and

FIG. 14 is a schematic structural diagram of an embodiment of an electronic vaporization device according to this application.

### DETAILED DESCRIPTION

In an embodiment, the present invention provides a heating body and an electronic vaporization device, to resolve the foregoing technical problems. To resolve the foregoing technical problems, a technical solution adopted by this application is to provide a heating body. The heating body includes:

a first heat conduction substrate, a second heat conduction substrate and a heating element; and the first heat conduction substrate, the heating element and the second heat conduction substrate are sequentially stacked and fixedly connected.

Optionally, surfaces of the first heat conduction substrate and the second heat conduction substrate that are arranged close to each other are both planes; and

the heating element includes a first connection portion, a main heating portion and a second connection portion that are sequentially connected; and the first connection portion and the second connection portion are configured to be electrically connected to an external power supply, so that the main heating portion is electrically connected to the external power supply to implement heating.

Optionally, the first heat conduction substrate, the second heat conduction substrate and the heating element are all of planar sheet structures.

Optionally, an outer edge of the main heating portion is flush with an outer edge of at least one of the first heat conduction substrate and/or the second heat conduction substrate.

Optionally, the main heating portion includes a first sub-heating portion, a second sub-heating portion and a third sub-heating portion;

the first sub-heating portion and the second sub-heating portion extend along edges of the first heat conduction substrate and the second heat conduction substrate; one end of the first sub-heating portion and one end of the second sub-heating portion are connected to the first connection portion and the second connection portion respectively; and the third sub-heating portion is disposed between the first sub-heating portion and the second sub-heating portion, and two ends are connected to the first sub-heating portion and the second sub-heating portion respectively; and

the other ends of the first sub-heating portion and the second sub-heating portion are connected to each other or separated from each other.

Optionally, the first sub-heating portion and the second sub-heating portion are flush with outer edges on different sides of the first heat conduction substrate and the second heat conduction substrate respectively.

Optionally, the heating body further includes an edge seal member disposed between the first heat conduction substrate and the second heat conduction substrate; and the edge seal member at least partially surrounds the heating element; and

an outer edge of at least one of the first heat conduction substrate and the second heat conduction substrate is flush with an outer edge of the edge seal member.

Optionally, the outer edges of the edge seal member, the first heat conduction substrate and the second heat conduction substrate are flush and form an accommodating space; and the main heating portion is accommodated in the accommodating space.

Optionally, the edge seal member is at least one of a metal sheet layer, a ceramic sheet layer or a sealing glaze layer.

Optionally, the heating element includes a first connection portion, a main heating portion and a second connection portion that are sequentially connected; and the first connection portion and the second connection portion are configured to be electrically connected to an external power supply, so that the main heating portion is electrically connected to the external power supply to implement heating; and

at least one of opposite surfaces of the first heat conduction substrate and the second heat conduction substrate is provided with a groove for accommodating the main heating portion.

Optionally, edges of both the first heat conduction substrate and the second heat conduction substrate are flush.

Optionally, each of the first heat conduction substrate and the second heat conduction substrate includes a mounting portion and an insertion portion, a width of the insertion portion is less than a width of the mounting portion, the insertion portions on the first heat conduction substrate and the second heat conduction substrate together form an insert-connection portion of the heating body, and the insert-connection portion is configured to be at least partially inserted into a to-be-heated element to heat the to-be-heated element. Optionally, a side of the mounting portion of the second heat conduction substrate away from the insertion portion is provided with an opening, so that at least partial regions of the first connection portion and the second connection portion are exposed from the opening.

Optionally, a surface of the first heat conduction substrate opposite to the second heat conduction substrate is provided with a groove, and the groove accommodates the heating element.

To resolve the foregoing technical problems, another technical solution adopted by this application is to provide an electronic vaporization device. The electronic vaporization device includes a heating body and a vaporization device body.

The heating body is mounted on the vaporization device body, and a power supply is disposed in the vaporization device body, and the power supply is electrically connected to the heating body to provide power to the heating body; the heating body is configured to heat and vaporize the to-be-heated element; and the heating body is the heating body described above.

Beneficial effects of this application are as follows: This application provides an electronic vaporization device and a heating body thereof. A first heat conduction substrate, a heating element and a second heat conduction substrate are sequentially stacked and fixedly connected, and the heating element is clamped between the first heat conduction substrate and the second heat conduction substrate that are high in strength, so that the overall strength of the heating body is improved, meanwhile, the heat conduction substrates on two sides of the heating element can achieve uniform heat conduction, so that the heating body uniformly generates heat. Further, the first heat conduction substrate, the heating element and the second heat conduction substrate are set of planar sheet structures, so that they can be directly stacked, and further attached and fixedly connected, so that the assembly difficulty and process requirements are reduced. Therefore, the heating body formed by using this solution has high structural strength, uniform heating, high stability and reliability, and simple assembly and low costs.

The technical solutions in embodiments of this application are clearly and completely described below with reference to the accompanying drawings in the embodiments of this application. Apparently, the described embodiments are merely some rather than all of the embodiments of this application. All other embodiments obtained by a person of ordinary skill in the art based on the embodiments of this application without creative efforts shall fall within the protection scope of this application.

It should be noted that if directional indications (for example, up, down, left, right, front, and back) involved in the embodiments of this application, the directional indications are only used for explaining relative position relationships, movement situations or the like between the various components in a specific posture (as shown in the accompanying drawings). If the specific posture changes, the directional indications change accordingly.

In addition, if description, for example, “first” and “second” is involved in the embodiments of this application, the description, for example, “first” and “second”, is merely intended for a purpose of description, and shall not be understood as an indication or implication of relative importance or implicit indication of the number of indicated technical features. Therefore, a feature defined by “first” and “second” can explicitly or implicitly include at least one of the features. In addition, technical solutions between the embodiments may be combined with each other, provided that the combination of the technical solutions can be implemented by a person of ordinary skill in the art. When the combined technical solutions conflict with each other or cannot be implemented, it should be considered that such a combination of the technical solutions does not exist or is not within the protection scope of this application.

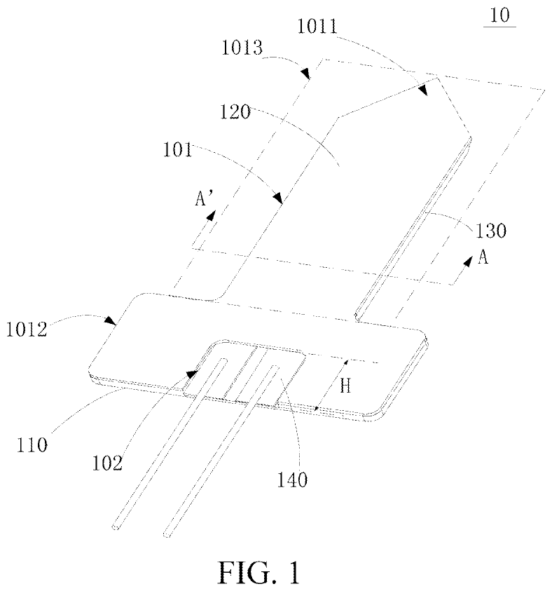

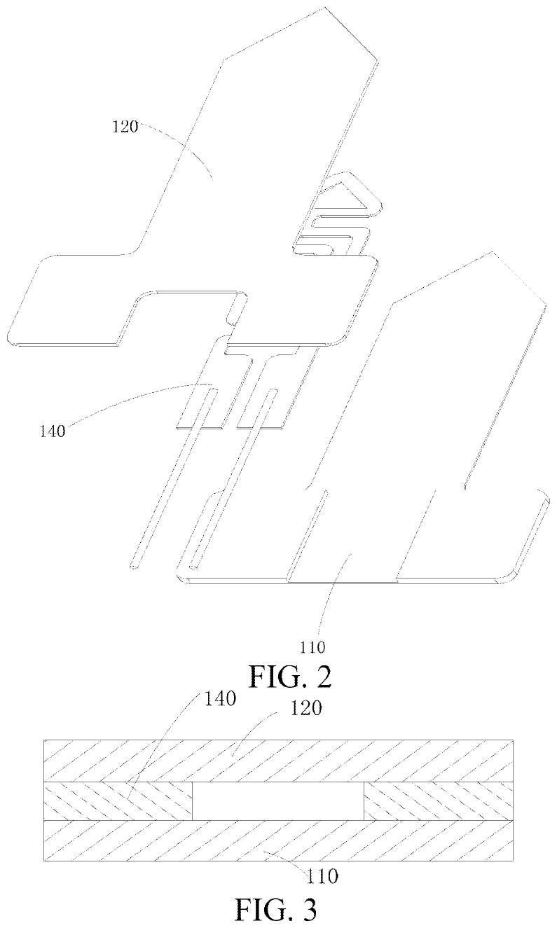

Referring to FIG. 1 to FIG. 3, FIG. 1 is a schematic structural diagram of an embodiment of a heating body according to this application. FIG. 2 is an exploded view of an embodiment of the heating body shown in FIG. 1. FIG. 3 is a cross-sectional view of an implementation of the heating body shown in FIG. 1 at an A-A′ section.

The heating body 10 includes a substrate 101 and a heating element 140. The substrate 101 may include a first heat conduction substrate 110 and a second heat conduction substrate 120, and the first heat conduction substrate 110 and the second heat conduction substrate 120 are disposed opposite to each other to form an accommodating space; and the heating element 140 is at least partially disposed in the accommodating space.

Specifically, the first heat conduction substrate 110 and the second heat conduction substrate 120 may be attached to two opposite sides of the heating element 140 respectively and fixedly connected to the heating element 140. Therefore, in this solution of this application, the first heat conduction substrate and the second heat conduction substrate are attached to the two opposite sides of the heating element respectively and fixedly connected to the heating element, so that the processing precision of the first heat conduction substrate and the second heat conduction substrate can be reduced, and a manner of welding or bonding between edges of the first heat conduction substrate and the second heat conduction substrate used enables that the first heat conduction substrate and the second heat conduction substrate form an edge-sealed substrate to encapsulate the heating element. Therefore, the assembly difficulty can be reduced and the assembly efficiency can be improved. In addition, the first heat conduction substrate and the second heat conduction substrate on the two sides of the heating element can achieve uniform heat conduction, and improve the heating uniformity of the heating body.

In this embodiment, after being sequentially stacked, the first heat conduction substrate 110, the heating element 140 and the second heat conduction substrate 120 are fixedly connected by welding or bonding.

An edge of the substrate 101 may be welded by laser spot welding or the like, so that the edges of the first heat conduction substrate 110 and the second heat conduction substrate 120 may be welded and fixed, thereby implementing a fixed connection among the first heat conduction substrate 110, the heating element 140 and the second heat conduction substrate 120.

It may be understood that, when the first heat conduction substrate 110 and the second heat conduction substrate 120 are fixedly connected by using a welding process, a metal heat conduction substrate may be selected.

Alternatively, the first heat conduction substrate 110, the heating element 140 and the second heat conduction substrate 120 may be bonded and fixedly connected by using high temperature-resistant insulating glue. The insulating glue may be separately disposed between the first heat conduction substrate 110 and the heating element 140 and between the second heat conduction substrate 120 and the heating element 140. Alternatively, the insulating glue may be accommodated in an internal space defined by the first heat conduction substrate 110, the heating element 140 and the second heat conduction substrate 120; and further, the insulating glue may alternatively be disposed along the edge of the substrate 101, to bond and fixedly connect the first heat conduction substrate 110, the heating element 140 and a part of the second heat conduction substrate 120 located in an edge region of the substrate 101.

It may be understood that, when the first heat conduction substrate 110 and the second heat conduction substrate 120 are fixedly connected by using a bonding process, a metal heat conduction substrate or a ceramic heat conduction substrate may be selected.

A manner of fixedly connecting the first heat conduction substrate 110, the heating element 140 and the second heat conduction substrate 120 may be selected according to sizes of the first heat conduction substrate 110, the heating element 140 and the second heat conduction substrate 120 and whether the edges are aligned or a type of the heat conduction substrate.

Specifically, further referring to FIG. 3, in this embodiment, the first heat conduction substrate 110, the heating element 140 and the second heat conduction substrate 120 all have the same size in a width direction. Therefore, the two opposite sides of the heating element 140 may be aligned with two opposite sides of the first heat conduction substrate 110 in the width direction, and may be aligned with two opposite sides of the second heat conduction substrate 120 in the width direction. The two opposite sides of the heating element 140 herein may correspond to outer side walls of the first sub-heating portion 1401 and the second sub-heating portion 1402 respectively described later.

In this case, the insulating glue may be separately disposed between the first heat conduction substrate 110 and the heating element 140 and between the second heat conduction substrate 120 and the heating element 140, to bond and fix the first heat conduction substrate, the heating element, and the second heat conduction substrate. It should be noted that, because the heating body needs to work in a high temperature environment, the insulating glue used for bonding, fixing and insulation generally needs to use inorganic high temperature-resistant glue.

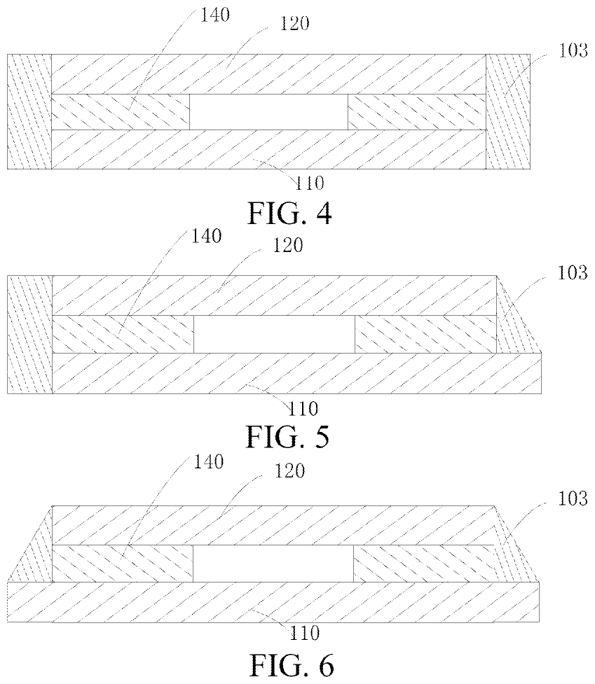

Referring to FIG. 4, FIG. 4 is a cross-sectional view of another implementation of the heating body shown in FIG. 1 at an A-A′ section.

Similarly, in this embodiment, the first heat conduction substrate 110 and the second heat conduction substrate 120 are attached to two opposite sides of the heating element 140 respectively. The first heat conduction substrate 110 and the second heat conduction substrate 120 are fixedly connected by welding or bonding.

A fixed connection portion 103 may be formed at edges of the first heat conduction substrate 110 and the second heat conduction substrate 120, to fixedly connect the edges of the first heat conduction substrate 110 and the second heat conduction substrate 120. The fixed connection portion 103 may be a welding portion formed by perform a welding operation on the edges of the first heat conduction substrate 110 and the second heat conduction substrate 120; or the fixed connection portion may be a bonding portion formed by bonding and fixing the edges of the first heat conduction substrate 110 and the second heat conduction substrate 120.

The fixed connection portion 103 is disposed along an edge of the substrate 101. The first heat conduction substrate 110, the second heat conduction substrate 120 and the fixed connection portion 103 form an accommodating space covering the heating element 140, and the heating element 140 is at least partially accommodated in the accommodating space.

In this embodiment, outer contours of the first heat conduction substrate 110 and the second heat conduction substrate 120 may be set to be the same, and are substantially the same as a shape of the heating element 140.

When the first heat conduction substrate 110 and the second heat conduction substrate 120 are attached to the two opposite sides of the heating element 140 respectively, two sidewalls of the first heat conduction substrate 110 and the second heat conduction substrate 120 in the width direction (that is, two sidewalls of the first heat conduction substrate 110 and the second heat conduction substrate 120 along a length direction) may be aligned with the two opposite sides of the heating element 140 respectively. That is, width sizes of the first heat conduction substrate 110, the second heat conduction substrate 120 and the heating element 140 may be set to be the same.

In this solution, the fixed connection portion 103 may be formed at edge regions of the first heat conduction substrate 110 and the second heat conduction substrate 120, so that the first heat conduction substrate 110 and the second heat conduction substrate 120 form an edge-sealed accommodating space.

Referring to FIG. 5, FIG. 5 is a cross-sectional view of another implementation of the heating body shown in FIG. 1 at an A-A′ section.

A difference between the heating body 10 in this implementation and the heating body in the implementation provided in FIG. 3 lies in that in this implementation, a width size of one of the first heat conduction substrate 110 and the second heat conduction substrate 120 may be set to be greater than a width size of the heating element 140.

In this embodiment, for example, the width size of the first heat conduction substrate 110 is greater than the width size of the heating element 140.

The second heat conduction substrate 120 is disposed on one side of the heating element 140, and is aligned with the two sides of the heating element 140 in the width direction. The first heat conduction substrate 110 is disposed on the other side of the heating element 140. One sidewall of the first heat conduction substrate 110 may be aligned with the heating element 140; or in the width direction, two opposite sidewalls of the first heat conduction substrate 110 may not be aligned with the heating element 140.

Because the width size of the first heat conduction substrate 110 is greater than the width size of the heating element 140, a partial region of the first heat conduction substrate 110 may extend beyond a side edge of the heating element 140, and in this case, the fixed connection portion 103 may be formed based on the partial region of the first heat conduction substrate 110 extending beyond the side edge of the heating element 140.

Optionally, a cross section of the fixed connection portion 103 may be triangular or trapezoidal (or approximately triangular or trapezoidal), so that a bevel angle may be formed between the sidewalls of the formed substrate 101, to facilitate insertion of the substrate 101 into to-be-heated tobacco or the like.

It should be noted that, the triangular or trapezoidal fixed connection portion 103 may be formed by grinding a welding region or a bonding region.

Referring to FIG. 6, FIG. 6 is a cross-sectional view of another implementation of the heating body shown in FIG. 1 at an A-A′ section.

A difference between the heating body 10 in this implementation and the heating body in the implementation provided in FIG. 3 lies in that in this implementation, width sizes of the first heat conduction substrate 110 and the second heat conduction substrate 120 are both greater than a width size of the heating element 140.

In a width direction, two opposite sides of the first heat conduction substrate 110 and the second heat conduction substrate 120 are disposed beyond the two opposite sides of the heating element 140 respectively.

In this case, fixed connection portions 103 may be formed on two opposite sides of the first heat conduction substrate 110 and the second heat conduction substrate 120, so that the first heat conduction substrate 110 and the second heat conduction substrate 120 may be fixedly connected.

In the foregoing embodiment, both the first heat conduction substrate 110 and the second heat conduction substrate 120 are of planar sheet structures. The planar sheet structure herein may be expressed as: surfaces of the first heat conduction substrate 110 and the second heat conduction substrate 120 that are arranged close to each other are both planes, and surfaces of the first heat conduction substrate 110 and the second heat conduction substrate 120 that are arranged away from each other are also both planes.

In another embodiment, a surface of at least one of the first heat conduction substrate 110 and the second heat conduction substrate 120 away from one side of the other may be set as a curved surface, and the curved surface may be an arc-shaped surface or a wave-shaped surface. An advantage of this solution lies in that, at least one outer surface of the substrate 101 formed by the first heat conduction substrate 110 and the second heat conduction substrate 120 is set as a curved surface, so that a contact area between the substrate 101 and the to-be-heated tobacco or the like can be increased, and the heating efficiency can be improved.

In the implementations provided in FIG. 3 to FIG. 6, the substrate 101 is fixed by directly welding or directly bonding the edges of the first heat conduction substrate 110 and the second heat conduction substrate 120. In another embodiment, an edge seal member may also be provided.

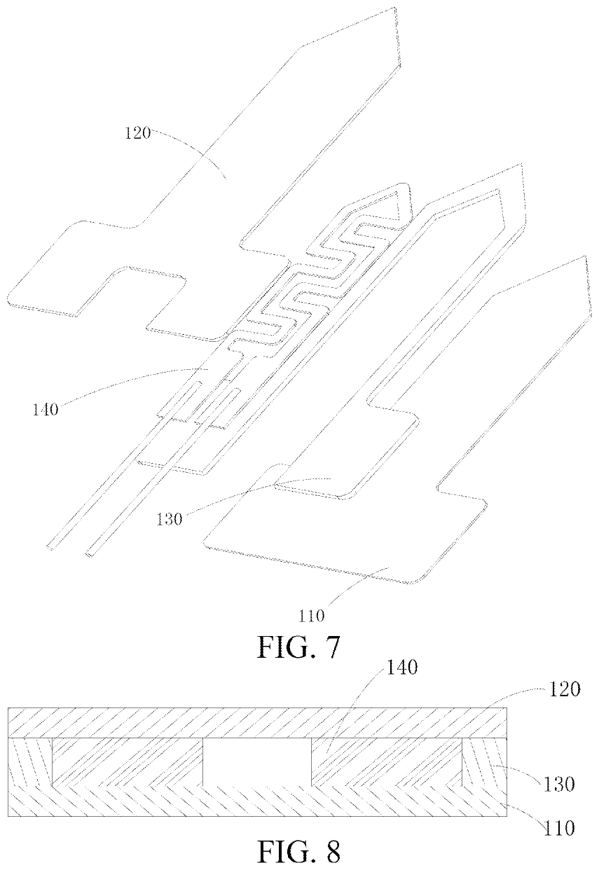

Specifically, referring to FIG. 1, FIG. 7 and FIG. 8, FIG. 7 is an exploded view of another implementation of the heating body shown in FIG. 1. FIG. 8 is a cross-sectional view of another implementation of the heating body shown in FIG. 1 at an A-A′ section.

The substrate 101 may further include an edge seal member 130. The first heat conduction substrate 110, the second heat conduction substrate 120 and the edge seal member 130 may be separately formed components respectively. The edge seal member 130 is disposed between the first heat conduction substrate 110 and the second heat conduction substrate 120, two opposite sides of the edge seal member 130 are connected to the edge regions of the first heat conduction substrate 110 and the second heat conduction substrate 120 respectively, and a position of the edge seal member 130 is then welded and bonded to form the foregoing accommodating space, to place the heating element 140.

In this embodiment, sizes of outer contours of the first heat conduction substrate 110 and the second heat conduction substrate 120 may be both set to be greater than a size of an outer contour of the heating element 140. Therefore, when the first heat conduction substrate 110, the heating element 140 and the second heat conduction substrate 120 are sequentially stacked, two opposite sides of the outer contour of the heating element 140 are not aligned with the two opposite sides of the substrate 101. That is, if the two opposite sides of the outer contour of the heating element 140 are recessed inward relative to the two opposite sides of the substrate 101, the edge seal member 130 may be configured to be filled in this recess. The first heat conduction substrate 110, the second heat conduction substrate 120 and the edge seal member 130 are welded or bonded, so that the first heat conduction substrate 110, the second heat conduction substrate 120 and the edge seal member 130 may be fixedly connected to form the substrate 101, and the first heat conduction substrate 110, the second heat conduction substrate 120 and the edge seal member 130 may define an accommodating space for disposing the heating element 140.

The edge seal member 130 is at least one of a metal sheet layer, a ceramic sheet layer or a sealing glaze layer. It should be noted that, different from a manner of disposing the metal sheet layer and the ceramic sheet layer, the sealing glaze layer may directly fill glaze in the recess, which is cured and formed by high-temperature sintering or the like, to finally form a structure of the edge seal member 130.

In the foregoing embodiment, the edge seal member 130, the first heat conduction substrate 110 and the second heat conduction substrate 120 are separate components respectively. In another embodiment, the edge seal member 130 may alternatively be integrally formed with one of the first heat conduction substrate 110 and the second heat conduction substrate 120.

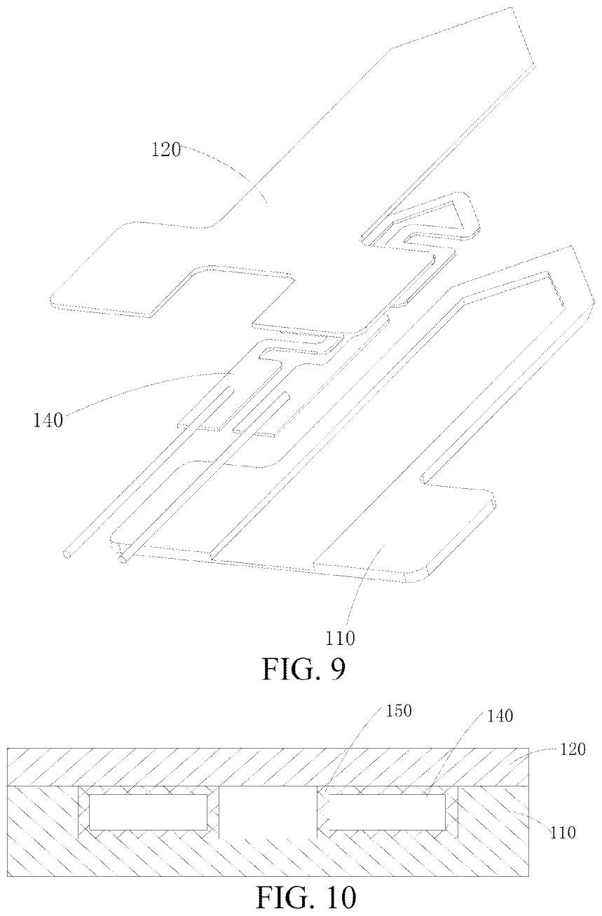

Specifically, referring to FIG. 1, FIG. 9 and FIG. 10, FIG. 9 is an exploded view of another implementation of the heating body shown in FIG. 1. FIG. 10 is a cross-sectional view of another implementation of the heating body shown in FIG. 1 at an A-A′ section.

In this embodiment, the edge seal member may be integrally formed with the first heat conduction substrate 110. The edge seal member may be disposed along an edge of the first heat conduction substrate 110, to define a groove portion 111 for placing the heating element 140. The second heat conduction substrate 120 may cover an opening of the groove portion 111.

Optionally, a surface of the heating element 140 may alternatively be filled with a heat conduction material to form a heat conduction layer 150. The heat conduction layer 150 may make the heating element 140 transfer heat to the substrate 101 quickly, to avoid heat accumulation, further result in uniform temperature distribution in different parts of the substrate 101.

In an implementation of this embodiment, a depth of the groove portion 111 on the first heat conduction substrate 110 may be set to be less than a thickness of the heating element 140. That is, when the heating element 140 is placed in the groove portion 111, the heating element 140 is partially located outside the groove portion 111. In this case, the second heat conduction substrate 120 may be attached to a surface of the heating element 140 facing away from a bottom of the groove portion 111, so that the first heat conduction substrate 110 and the second heat conduction substrate 120 are not in contact, and are connected by using the edge seal member 130.

An advantage of this solution lies in that, a position of disposing the heating element 140 may be positioned by providing the groove portion 111, and provided that the depth of the groove portion 111 only needs to be set to be less than the thickness of the heating element 140, a requirement for the processing precision of the groove portion 111 can be reduced, thereby reducing the processing difficulty of the first heat conduction substrate 110.

In another implementation, the depth of the groove portion 111 on the first heat conduction substrate 110 may alternatively be set to be greater than or equal to the thickness of the heating element 140.

The first heat conduction substrate 110 and the second heat conduction substrate 120 may both be metal sheets. Optionally, the groove portion 111 may be formed by performing laser cutting on the first heat conduction substrate 110, or may be formed through machining.

Further, in this implementation, when the first heat conduction substrate 110 and the second heat conduction substrate 120 are disposed on the two opposite sides of the heating element 140 respectively, heat conduction insulating glue may be filled in a gap among the first heat conduction substrate 110, the second heat conduction substrate 120 and the heating element 140. The heat conduction insulating glue may be used for fixing positions of the first heat conduction substrate 110, the heating element 140 and the second heat conduction substrate 120, to facilitate subsequent welding or bonding and fixing of the first heat conduction substrate 110 and the second heat conduction substrate 120. In addition, heat from the inside of the heating element 140 may also be quickly transferred to the substrate 101, thereby improving the temperature uniformity of the substrate 101. Further, in this embodiment, the first heat conduction substrate 110, the second heat conduction substrate 120 and the edge seal member 130 are all metal sheets, and the first heat conduction substrate 110, the edge seal member 130 and the second heat conduction substrate 120 are sequentially stacked and then fixedly connected to form the substrate 101 as described above. The opposite surfaces of the first heat conduction substrate 110 and the second heat conduction substrate 120 are both planes.

The heating element 140 includes a conductive body and an insulating layer coating an outer surface of the conductive body, so that the heating element 140 is insulated from the substrate 101 formed by the first heat conduction substrate 110 and the second heat conduction substrate 120.

Therefore, by coating the insulating layer on the conductive body of the heating element 140, the first heat conduction substrate 110 and the second heat conduction substrate 120 do not need to be insulated. Therefore, when the first heat conduction substrate 110 and the second heat conduction substrate 120 are processed, outer surfaces of the first heat conduction substrate 110 and the second heat conduction substrate 120 may be set as smooth surfaces, to ensure the smoothness of the outer surfaces of the first heat conduction substrate 110 and the second heat conduction substrate 120.

Further, in this embodiment, the heating body 10 may be at least partially inserted into the tobacco, to heat and vaporize the tobacco or e-liquid. Therefore, by ensuring the smoothness of the outer surfaces of the first heat conduction substrate 110 and the second heat conduction substrate 120, a problem of tobacco bonding on the outer surfaces of the second heat conduction substrate 120 and the first heat conduction substrate 110 can be avoided.

In this embodiment, the substrate 101 may protect the heating element 140. In addition, the first heat conduction substrate 110 and the second heat conduction substrate 120 may both be metal sheets, where the first heat conduction substrate 110, the second heat conduction substrate 120 and the edge seal member 130 may all be made of materials with better heat conduction coefficients. For example, the first heat conduction substrate 110, the second heat conduction substrate 120 and the edge seal member 130 may be made of at least one of stainless steel, a titanium-based composite material, a tungsten-based composite material, titanium metal or titanium alloy.

Further, a first end of the substrate 101 is configured to constitute an insert-connection portion 1011, and the insert-connection portion 1011 is configured to be at least partially inserted into a to-be-heated element to heat the to-be-heated element; and a second end opposite to the first end of the substrate 101 is provided with an opening 102, to partially expose the heating element 140. A part of the heating element 140 exposed from the opening 102 may be configured to be electrically connected to an external power supply, and the external power supply supplies power to the heating element 140, so that the heating element 140 may generate heat to heat the to-be-heated element.

Specifically, each of the first heat conduction substrate 110 and the second heat conduction substrate 120 includes a connected insertion portion and a connected mounting portion. In addition, the mounting portions of the first heat conduction substrate 110 and the second heat conduction substrate 120 are connected to each other to together constitute a mounting portion 1012 of the substrate 101; and the insertion portions of the first heat conduction substrate 110 and the second heat conduction substrate 120 are connected to each other to constitute an insertion portion 1013 of the substrate 101. If one end of the insertion portion 1013 of the substrate 101 away from the mounting portion 1012 is a tip end, the tip end may constitute the insert-connection portion 1011 of the substrate 101.

One side of the second heat conduction substrate 120 away from the insert-connection portion 1011 of the substrate 101 is provided with a notch. Therefore, after the first heat conduction substrate 110 cooperates with the second heat conduction substrate 120, the foregoing opening 102 may be formed, and the heating element may be partially exposed through the notch; and in this case, the edge seal member 130 is disposed corresponding to an entire edge of the insertion portion and other edges of the mounting portion other than the notch.

In an embodiment, the first heat conduction substrate 110 is in a long strip shape. One end of the first heat conduction substrate 110 is chamfered to form the insert-connection portion 1011, and the other end is of a flush structure. That is, the first heat conduction substrate 110 includes a rectangular part and a triangular part disposed at one end of the rectangular part.

When a groove portion 111 is provided on the first heat conduction substrate 110 and/or the second heat conduction substrate 120, the groove portion 111 also includes a rectangular part and a triangular part disposed at one end of the rectangular part. A shape of the second heat conduction substrate 120 matches the shape of the first heat conduction substrate 110.

A part of a second end of the first heat conduction substrate 110 close to the substrate 101 is exposed relative to the second heat conduction substrate 120, to partially expose the heating element 140. Specifically, a length of the second heat conduction substrate 120 may be set to be less than a length of the first heat conduction substrate 110. At a position close to the second end of the substrate 101, one side of the heating element 140 close to the second heat conduction substrate 120 may be used as an exposed surface of the heating element 140, and the exposed surface may be configured to be electrically connected to the external power supply.

An exposed portion of the heating element 140 located at the second end of the substrate 101 may be electrically connected to the external power supply by soldering conductive wires, where a length H of the exposed portion of the heating element 140 located at the second end of the substrate 101 may be 2-3 mm. For example, the length H may be 2 mm, 2.5 mm or 3 mm.

In the foregoing implementation, the insertion portion 1013 formed by the tip ends of the first heat conduction substrate 110 and the second heat conduction substrate 120 together may be used as an insert-connection tip end to be inserted into the to-be-heated tobacco. The mounting portion 1012 formed by the first heat conduction substrate 110 and the second heat conduction substrate 120 together may be configured to be fixedly connected to a preset mounting component. A width of the insertion portion 1013 is less than a width of the mounting portion 1012.

In this solution, the width of the mounting portion 1012 is set to be greater than the width of the insertion portion 1013, to improve the strength of the mounting portion 1012 of the substrate 101 and the mounting stability of the substrate 101.

Optionally, in the implementation described above, the second heat conduction substrate 120 and the first heat conduction substrate 110 may be fixedly connected by welding or bonding with high temperature-resistant inorganic glue.

For example, the second heat conduction substrate 120 and the first heat conduction substrate 110 may be welded and fixed by welding such as spot welding or laser welding, or the second heat conduction substrate 120 and the first heat conduction substrate 110 may be bonded and fixed by using insulating glue with good heat resistance.

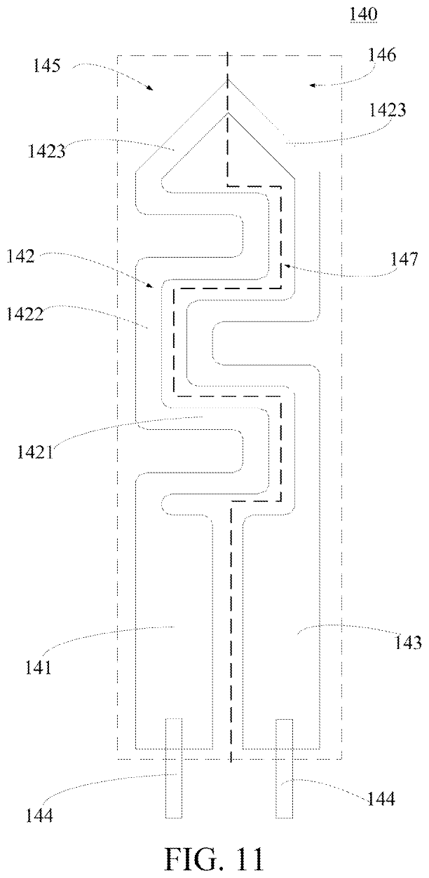

Further referring to FIG. 11, FIG. 11 is a schematic structural diagram of an embodiment of a heating element in a heating body according to this application.

The heating element 140 includes a first connection portion 141, a main heating portion 142, a second connection portion 143 and two connecting wires 144 that are sequentially connected.

The first connection portion 141 and the second connection portion 143 are arranged side by side and spaced apart from the second end of the substrate 101 and are exposed through the opening 102; and the first connection portion 141 and the second connection portion 143 are configured to be electrically connected to the external power supply, so that the main heating portion 142 is electrically connected to the external power supply to generate heat. Impedance of the first connection portion 141 and the second connection portion 143 is both less than impedance of the main heating portion 142.

Specifically, cross-sectional areas of the first connection portion 141 and the second connection portion 143 are both greater than a cross-sectional area of the main heating portion 142.

In this embodiment, the two connecting wires 144 may be electrically connected to the first connection portion 141 and the second connection portion 143 respectively, so that the first connection portion 141 and the second connection portion 143 may be electrically connected to the external power supply. Specifically, each ends of the two connecting wires 144 may be electrically connected to the first connection portion 141 and the second connection portion 143 respectively; and the other ends of the two connecting wires 144 may be electrically connected to positive and negative electrodes of the external power supply respectively.

Each ends of the two connecting wires 144 may be electrically connected to parts of the first connection portion 141 and the second connection portion 143 exposed from the opening 102 respectively, for example, may be welded and fixed, and a joint between the connecting wire 144 and the first connection portion 141 or the second connection portion 143 may be covered with an insulating protective layer. By using the insulating protective layer, the connecting wire 144 and the first connection portion 141 or the second connection portion 143 may be covered, so that the connecting wire 144 and the part exposed of the first connection portion 141 or the second connection portion 143 can be protected.

In this embodiment, the insulating protective layer may be formed by sintering an insulating material. Specifically, after each ends of the two connecting wires 144 are electrically connected to the first connection portion 141 and the second connection portion 143 respectively, connected parts may be glazed.

The main heating portion 142 may be in a continuous broken line. Specifically, the main heating portion 142 may include a plurality of transverse heating portions 1421 and a plurality of longitudinal heating portions 1422, and the plurality of transverse heating portions 1421 and the plurality of longitudinal heating portions 1422 are sequentially and alternately connected.

Referring to FIG. 7, the main heating portion 142 includes a plurality of transverse heating portions 1421, a plurality of longitudinal heating portions 1422 and a plurality of oblique heating portions 1423. The main heating portion 142 may be divided into a first sub-heating region 145 and a second sub-heating region 146, and the first sub-heating region 145 and the second sub-heating region 146 may both include a plurality of transverse heating portions 1421, a plurality of longitudinal heating portions 1422 and at least one oblique heating portion 1423.

The first sub-heating region 145 and the second sub-heating region 146 may both include an oblique heating portion 1423, and two oblique heating portions 1423 are connected at one end to match a shape of the tip end of the insert-connection portion 1011. After being connected, the two oblique heating portions 1423 may be disposed at positions corresponding to the insert-connection portion 1011, to supply heat to a region of the insert-connection portion 1011.

Ends of the first sub-heating region 145 and the second sub-heating region 146 away from respective oblique heating portions 1423 may be connected to the first connection portion 141 and the second connection portion 143 respectively.

For the first sub-heating region 145, the plurality of transverse heating portions 1421 and the plurality of longitudinal heating portions 1422 disposed between the first connection portion 141 and the oblique heating portion 1423 of the first sub-heating region may be sequentially and alternately connected; and similarly, for the second sub-heating region 146, the plurality of transverse heating portions 1421 and the plurality of longitudinal heating portions 1422 disposed between the second connection portion 143 and the oblique heating portion 1423 of the second sub-heating region may alternatively be sequentially and alternately connected. In addition, a broken line groove 147 with the same width everywhere may be formed between the first sub-heating region 145 and the second sub-heating region 146.

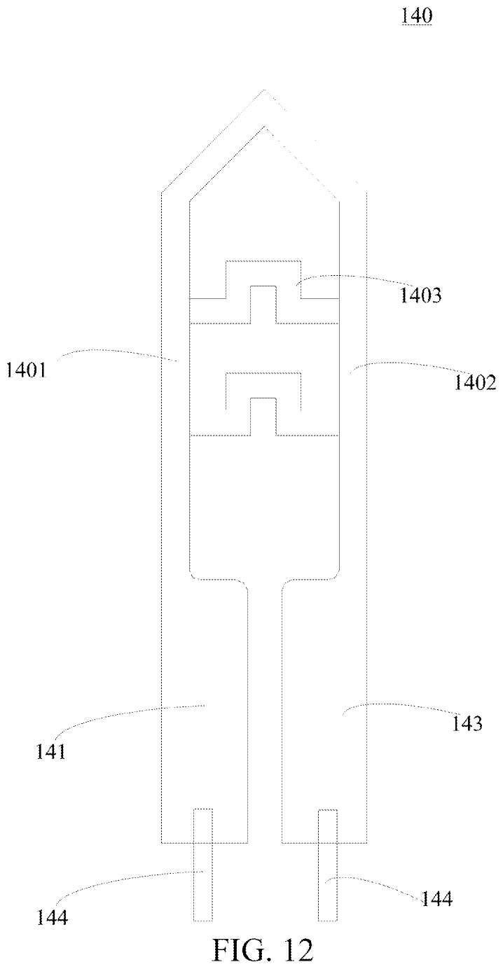

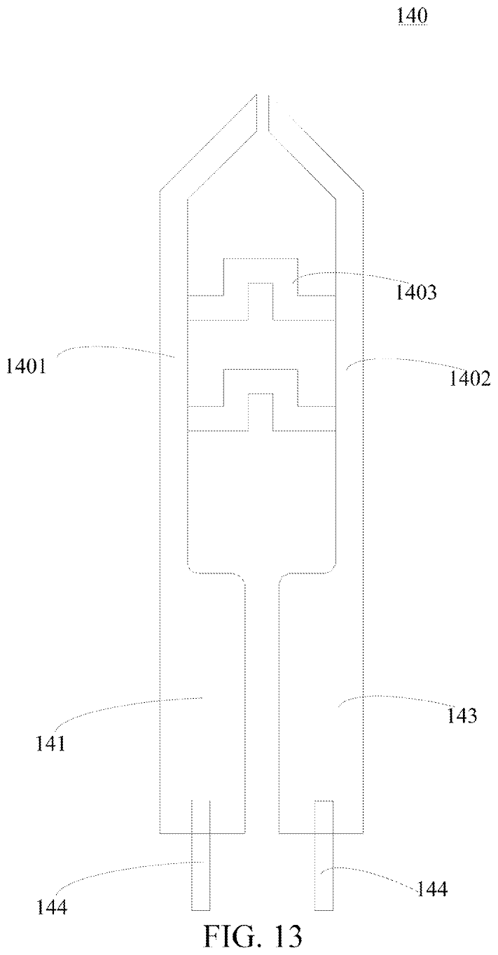

Alternatively, in another embodiment, the heating element 140 may alternatively be set to be in another shape. Referring to FIG. 12, FIG. 12 is a schematic structural diagram of another embodiment of a heating element in a heating body according to this application.

In this embodiment, the heating element 140 includes a first connection portion 141, a main heating portion 142, a second connection portion 143 and two connecting wires 144 that are sequentially connected. A connection relationship among the first connection portion 141, the main heating portion 142, the second connection portion 143 and the two connecting wires 144 is the same as that in the embodiment shown in FIG. 7.

In this embodiment, the main heating portion 142 includes a first sub-heating portion 1401, a second sub-heating portion 1402 and a third sub-heating portion 1403.

The first sub-heating portion 1401 and the second sub-heating portion 1402 extend along the edge of the substrate 101; and

one end of the first sub-heating portion 1401 and one end of the second sub-heating portion 1402 are connected to the first connection portion 141 and the second connection portion 143 respectively; the other end of the first sub-heating portion 1401 and the other end of the second sub-heating portion 1402 both extend toward the first end of the substrate 101 and are connected to each other; and the third sub-heating portion 1403 is disposed between the first sub-heating portion 1401 and the second sub-heating portion 1402, and the two ends are connected to the first sub-heating portion 1401 and the second sub-heating portion 1402 respectively.

Optionally, the first sub-heating portion 1401 and the second sub-heating portion 1402 that are close to the first end of the substrate 101 may include broken line portions respectively, and the first sub-heating portion 1401 and the second sub-heating portion 1402 are close and connected to each other. In this case, the broken line portions on the first sub-heating portion 1401 and the second sub-heating portion 1402 may form a triangle that matches the insert-connection portion 1011 of the substrate 101.

In this embodiment, a quantity of the third sub-heating portions 1403 may be 1 or may be 2 or more, where the quantity may be set as required. By providing the third sub-heating portion 1403, the overall strength of the heating element 140 can be improved, and the stability of the overall shape of the heating element 140 can be improved.

Referring to FIG. 13, FIG. 13 is a schematic structural diagram of another embodiment of the heating element shown in FIG. 12.

In this embodiment, a difference from the heating element shown in FIG. 12 lies in that in this embodiment, the first sub-heating portion 1401 and the second sub-heating portion 1402 are spaced apart (that is, electrically disconnected) at a position close to the first end of the substrate 101. In this case, the first sub-heating portion 1401 and the second sub-heating portion 1402 may be electrically connected through the third sub-heating portion 1403 in a middle region.

Optionally, the heating element 140 may be a self-supporting metal heating element. The heating element 140 may be a metal sheet, and the conductive body of the heating element 140 may be a metal conductive body that has specific strength and is not easily deformed; and the metal conductive body may be made of one or more of nickel-chromium alloy, iron-chromium-aluminum alloy, nickel or tungsten. For example, a conductive body with a predetermined pattern is formed by cutting or etching a self-supporting metal sheet. The insulating layer of the heating element 140 may be formed on a surface of the conductive body in a forming manner of coating, sputtering or chemical etching and electrophoresis.

The forming manner of coating may include coating the nano-silica insulating coating on the surface of the conductive body to form an insulating layer; the forming manner of sputtering may include sputtering nitrides, oxides, carbides, or the like on the surface of the conductive body to form an insulating layer; and the forming manner of chemical etching and electrophoresis may include immersing the conductive body in a phosphate compound solution, and then performing chemical etching on the surface of the conductive body to form an insulating layer, or using an electrophoresis process on the surface of the conductive body to form an insulating layer.

After insulating processing on the surface of the heating element 140 is completed, the heating element 140 may be placed between the first heat conduction substrate 110 and the second heat conduction substrate 120, and the heating element 140 is packaged.

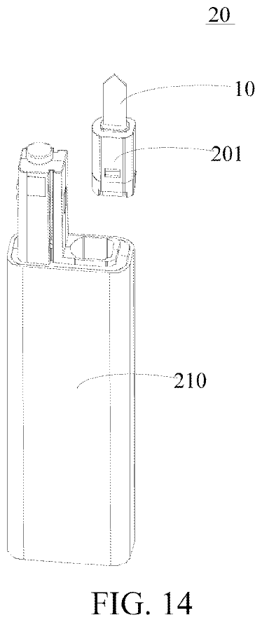

Further, based on the same invention-creation, this application further provides an electronic vaporization device. Referring to FIG. 14, FIG. 14 is a schematic structural diagram of an embodiment of an electronic vaporization device according to this application.

The electronic vaporization device 20 includes the heating body 10 described above and a vaporization device body 210; and

the heating body 10 may be mounted on the vaporization device body 210 by using a mounting base 201, the vaporization device body 210 is provided with a power supply, and the power supply is electrically connected to the heating body 10 to provide power to the heating body 10, so that the heating body 10 may be configured to heat and vaporize a to-be-heated element. The electronic vaporization device 20 may be an electronic cigarette, a vaporizer or the like, which is not further limited herein.

In summary, in this application, a first heat conduction substrate, a heating element and a second heat conduction substrate are sequentially stacked and fixedly connected, and the heating element is clamped between the first heat conduction substrate and the second heat conduction substrate that are high in strength, so that the overall strength of the heating body is improved, meanwhile, the heat conduction substrates on two sides of the heating element can achieve uniform heat conduction, so that the heating body uniformly generates heat. Further, the first heat conduction substrate, the heating element and the second heat conduction substrate are set of planar sheet structures, so that they can be directly stacked, and further attached and fixedly connected, so that the assembly difficulty and process requirements are reduced. Therefore, the heating body formed by using this solution has high structural strength, uniform heating, high stability and reliability, and simple assembly and low costs. Further, in the foregoing solutions of this application, the gap between the substrate and the heating element is filled with a heat conduction material, thereby improving the efficiency of the heating element transferring heat to the substrate, and further improving the uniformity of heat distribution on the substrate; and further, the edge seal member is disposed on the edges of the first heat conduction substrate and the second heat conduction substrate, so that after the first heat conduction substrate, the second heat conduction substrate and the edge seal member are fixedly connected, the accommodating space for placing the heating element is formed, thereby reducing the overall processing and assembly difficulty of the substrate, and improving the production efficiency of the heating body. The position of disposing the heating element may be positioned by providing the groove portion on the first heat conduction substrate and/or the second heat conduction substrate, and provided that the depth of the groove portion only needs to be set to be less than the thickness of the heating element, a requirement for the processing precision of the groove portion can be reduced, thereby reducing the processing difficulty of the first heat conduction substrate. The width of the mounting portion is set to be greater than the width of the insertion portion, to improve the strength of the mounting portion of the substrate and the mounting stability of the substrate.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating body, comprising:
a first heat conduction substrate;
a second heat conduction substrate; and
a heating element,
wherein the first heat conduction substrate, the heating element, and the second heat conduction substrate are sequentially stacked and fixedly connected.

2. The heating body of claim 1, wherein surfaces of the first heat conduction substrate and surfaces of the second heat conduction substrate that are arranged close to each other both comprise planes,
wherein the heating element comprises a first connection portion, a main heating portion, and a second connection portion that are sequentially connected, and
wherein the first connection portion and the second connection portion are electrically connectable to an external power supply such that the main heating portion is electrically connectable to the external power supply to implement heating.

3. The heating body of claim 2, wherein the first heat conduction substrate, the second heat conduction substrate, and the heating element all comprise planar sheet structures.

4. The heating body of claim 2, wherein an outer edge of the main heating portion is flush with an outer edge of at least one of the first heat conduction substrate and/or the second heat conduction substrate.

5. The heating body of claim 4, wherein the main heating portion comprises a first sub-heating portion, a second sub-heating portion, and a third sub-heating portion,
wherein the first sub-heating portion and the second sub-heating portion extend along edges of the first heat conduction substrate and the second heat conduction substrate,
wherein one end of the first sub-heating portion and one end of the second sub-heating portion are connected to the first connection portion and the second connection portion, respectively,
wherein the third sub-heating portion is disposed between the first sub-heating portion and the second sub-heating portion, and two ends are connected to the first sub-heating portion and the second sub-heating portion, respectively, and
wherein other ends of the first sub-heating portion and the second sub-heating portion are connected to each other or separated from each other.

6. The heating body of claim 5, wherein the first sub-heating portion and the second sub-heating portion are flush with outer edges on different sides of the first heat conduction substrate and the second heat conduction substrate, respectively.

7. The heating body of claim 2, further comprising:
an edge seal member disposed between the first heat conduction substrate and the second heat conduction substrate,
wherein the edge seal member at least partially surrounds the heating element, and
wherein an outer edge of at least one of the first heat conduction substrate and the second heat conduction substrate is flush with an outer edge of the edge seal member.

8. The heating body of claim 7, wherein outer edges of the edge seal member, the first heat conduction substrate, and the second heat conduction substrate are flush and form an accommodating space, and
wherein the main heating portion is accommodated in the accommodating space.

9. The heating body of claim 7, wherein the edge seal member comprises at least one of a metal sheet layer, a ceramic sheet layer, or a sealing glaze layer.

10. The heating body of claim 1, wherein the heating element comprises a first connection portion, a main heating portion, and a second connection portion that are sequentially connected,
wherein the first connection portion and the second connection portion are electrically connectable to an external power supply such that the main heating portion is electrically connectable to the external power supply to implement heating, and
wherein at least one of opposite surfaces of the first heat conduction substrate and the second heat conduction substrate comprises a groove configured to accommodate the main heating portion.

11. The heating body of claim 10, wherein edges of both the first heat conduction substrate and the second heat conduction substrate are flush.

12. The heating body of claim 2, wherein each of the first heat conduction substrate and the second heat conduction substrate comprises a mounting portion and an insertion portion, a width of the insertion portion being less than a width of the mounting portion,
wherein insertion portions on the first heat conduction substrate and the second heat conduction substrate together comprise an insert-connection portion of the heating body, and
wherein the insert-connection portion is at least partially insertable into a to-be-heated element to heat the to-be-heated element.

13. The heating body of claim 12, wherein a side of the mounting portion of the second heat conduction substrate away from the insertion portion comprises an opening such that at least partial regions of the first connection portion and the second connection portion are exposed from the opening.

14. The heating body of claim 13, wherein a surface of the first heat conduction substrate opposite the second heat conduction substrate comprises a groove, and
wherein the groove is configured to accommodate the heating element.

15. An electronic vaporization device, comprising:
the heating body of claim 1;
a vaporization device body; and
a power supply disposed in the vaporization device body,
wherein the heating body is mounted on the vaporization device body,
wherein the power supply is electrically connected to the heating body so as to provide power to the heating body, and
wherein the heating body is configured to heat and vaporize a to-be-heated element.
